(19) United States
(12) Patent Application Publication
(10) Pub. No.: US 2009/0271551 A1
(43) Pub. Date: Oct. 29, 2009

(54) EXPANSION STRUCTURE FOR MICROCOMPUTER

(75) Inventor: TA-YANG CHENG, Taipei (TW)

Correspondence Address: SCHMEISER, OLSEN & WATTS, 22 CENTURY HILL DRIVE, SUITE 302, LATHAM, NY, 12110, US

(73) Assignee: KING YOUNG TECHNOLOGY CO., LTD., TAIPEI CITY (TW)

(21) Appl. No.: 12/109,392

(22) Filed: Apr. 25, 2008

(51) Int. Cl. G06F 13/00

(52) U.S. Cl. 710/301

(57) ABSTRACT

An expansion structure for microcomputer includes a case having two end panels; a motherboard being installed in the case and provided with at least a connection port, a central processing unit, a plurality of electronic elements, a storage unit, and a plurality of push keys and external peripheral device connectors accessible at the end panels of the case; an adaptation connector arranged on the motherboard and electrically connected to the connection port, and the adaptation connector having a socket located on one of the end panels of the case; and an expansion interface card having an I/O connector provided along an edge thereof for plugging in the connection port on the motherboard. Desired external peripheral devices may be connected to the adaptation connector and/or the expansion interface card to conveniently achieve the expansion of the functionality of a microcomputer.

### FIELD OF THE INVENTION

The present invention relates to an expansion structure for microcomputer, and more particularly to an expansion structure for microcomputer that includes an adaptation connector and an expansion interface card for external peripheral devices to conveniently connect thereto to add additional functions to the microcomputer.

### BACKGROUND OF THE INVENTION

In the computer case of a personal computer, there are mounted various components, including motherboard, hard disc drive, floppy disc drive, CD-ROM drive, recorder, power supply, heat radiator, etc. The motherboard is electrically connected to other components via flat cables. Various factors, such as the large volume of the heat radiator, the improper arrangement of different components in the computer case, and the large space occupied by the flat cables, result in a huge volume of the computer case.

A microcomputer is developed to improve the large case of the personal computer. However, due to limited usable internal space, some components are omitted from the microcomputer case. As a result, the microcomputer loses certain functions and fails to satisfy some users.

### SUMMARY OF THE INVENTION

It is therefore a primary object of the present invention to provide an expansion structure for microcomputer, which allows external peripheral devices to be conveniently connected to a microcomputer to thereby add additional functions to the microcomputer.

To achieve the above and other objects, the expansion structure for microcomputer according to the present invention includes a microcomputer case having two end panels; a motherboard being installed in the case and provided with at least a connection port, a central processing unit, a plurality of electronic elements, a storage unit, and a plurality of push keys and external peripheral device connectors accessible at the end panels of the case; an adaptation connector arranged on the motherboard and electrically connected to the connection port, the adaptation connector having a socket located on one of the end panels of the case; and an expansion interface card having an I/O connector provided along an edge thereof for plugging in the connection port on the motherboard. Desired external peripheral devices may be connected to the adaptation connector and/or the expansion interface card to conveniently add additional functions to the microcomputer.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded perspective view showing a motherboard and an expansion interface card forming part of an expansion structure for microcomputer according to a first embodiment of the present invention;

FIG. 2 is an exploded perspective view of the expansion structure for microcomputer according to the first embodiment of the present invention;

FIG. 3 is an assembled sectional view of the first embodiment of the present invention;

FIG. 4 is an exploded perspective view showing a motherboard and an expansion interface card forming part of an expansion structure for microcomputer according to a second embodiment of the present invention; and

FIG. 5 is an exploded perspective view of the expansion structure for microcomputer according to the second embodiment of the present invention.

### DETAILED DESCRIPTION OF THE PREFERRED EMBODIMENTS

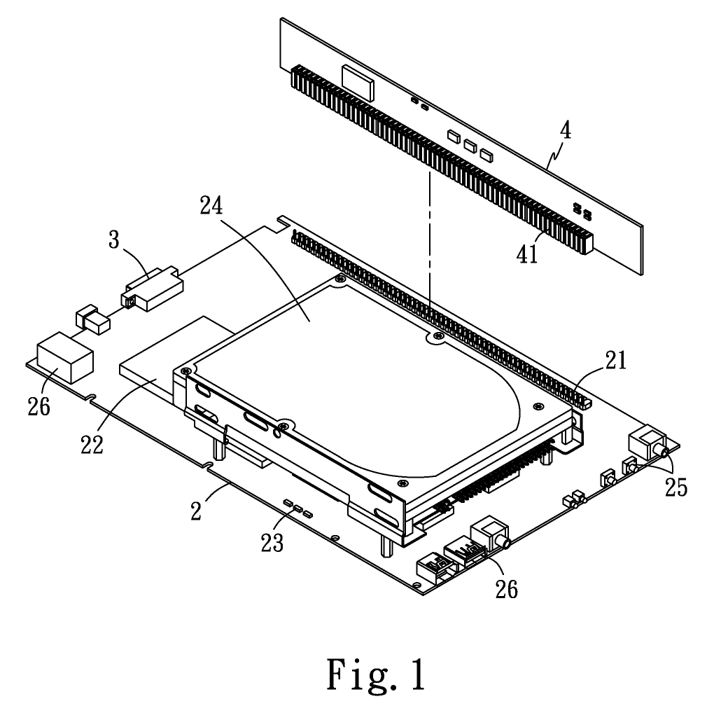

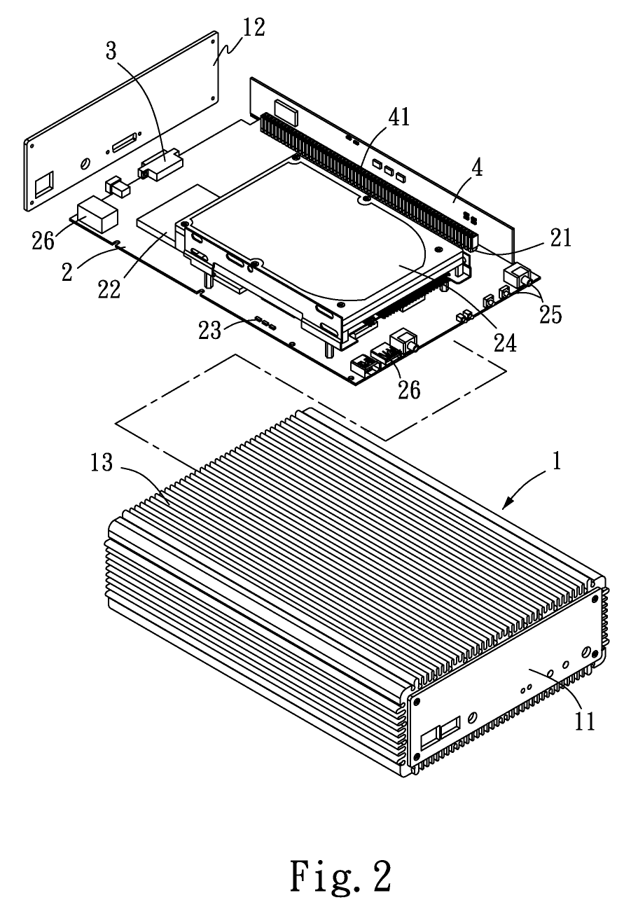

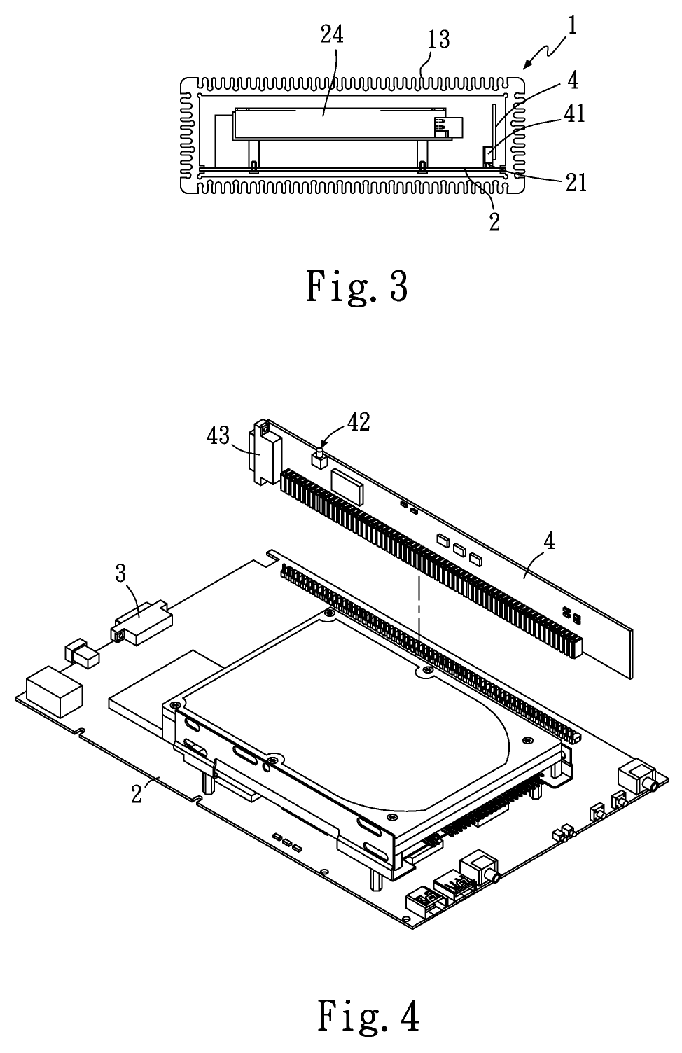

Please refer to FIGS. 1 to 3. An expansion structure for microcomputer according to a first embodiment of the present invention includes a case 1, a motherboard 2, an adaptation connector 3, and an expansion interface card 4.

Two end panels 11, 12 are respectively fixed at two open ends of the case 1. A plurality of radiating fins 13 is formed on outer surfaces of the case 1.

The motherboard 2 is installed in the case 1. On the motherboard 2, there are provided at least a connection port 21, a central processing unit 22, a plurality of electronic elements 23, a storage unit 24, and a plurality of push keys 25 and external peripheral device connectors 26 accessible at the end panels 11, 12.

The adaptation connector 3 is arranged on the motherboard 2 and electrically connected to the connection port 21. The adaptation connector 3 has a socket located on the end panel 12 of the case 1.

The expansion interface card 4 is provided along an edge thereof with an I/O connector 41 for plugging in the connection port 21. The expansion interface card 4 may be a video capture card, a sound card, an audio/visual (AV) processing card, or an external storage unit card. Alternatively, the expansion interface card 4 may be an all-in-one expansion interface card with more than one function.

When it is desired to add additional functions to the microcomputer, an adapter (not shown) for a desired external peripheral device (not shown) is mated with the adaptation connector 3 to electrically connect the external peripheral device to the motherboard 2. In this manner, the adaptation connector 3 cooperates with the expansion interface card 4 to enable the adding of additional functions to the microcomputer by connecting other external peripheral devices to the microcomputer according to actual need via the adaptation connector 3 and the expansion interface card 4, so that the microcomputer is more practical for use.

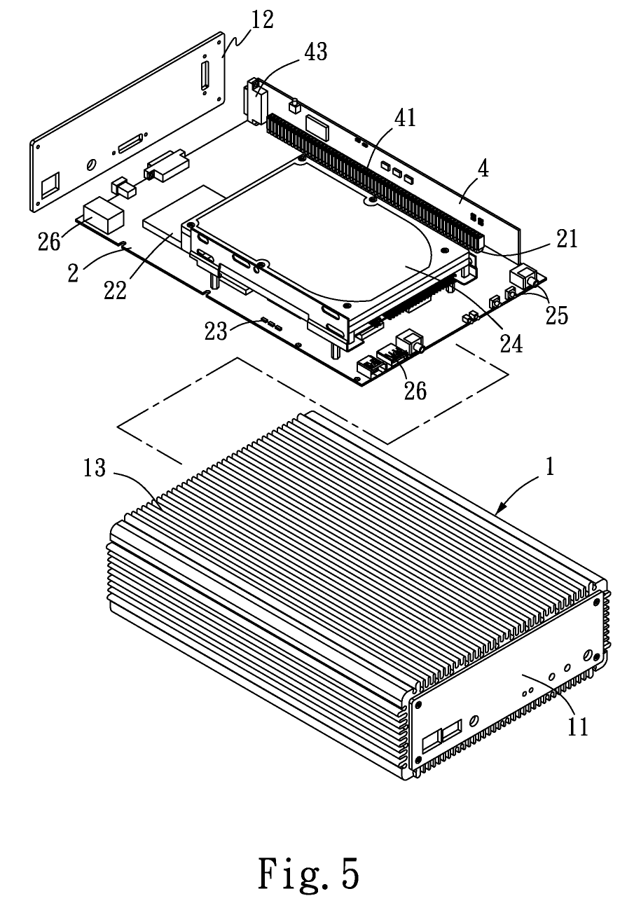

FIGS. 4 and 5 show an expansion structure for microcomputer according to a second embodiment of the present invention. The second embodiment is generally structurally similar to the first embodiment, except that the expansion interface card 4 is an all-in-one expansion interface card having more than one function, and is provided with a switch unit 42, which may be a manual switch. Alternatively, the switch unit 42 may be controlled via a software driver and a keyboard (not shown) On the all-in-one expansion interface card 4, there is also provided at least one expansion connector 43.

When it is desired to expand the functionality of the microcomputer, the adapters of different external peripheral devices (not shown) needed for the expansion are separately connected to the adaptation connector 3 on the motherboard 2 and the expansion connector 43 on the expansion interface card 4. The switch unit 42 can be manually operated or controlled via a software driver to switch between the external peripheral devices connected to the motherboard 2 via the adaptation connector 3 and the expansion interface card 4, so that one of the connected external peripheral devices may be selected via the switch unit 42 to meet actual need in use.

With the provision of the adaptation connector and the expansion interface card, the connection of desired peripheral devices to a microcomputer to expand the functionality of the microcomputer may be conveniently achieved. Therefore, the present invention is improved and practical for use to satisfy users' requirements.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An expansion structure for microcomputer, comprising:
a microcomputer case having two end panels;
a motherboard being installed in the case, and being provided at predetermined positions with at least a connection port, a central processing unit, a plurality of electronic elements, a storage unit, and a plurality of push keys and external peripheral device connectors accessible at the end panels;
an adaptation connector being arranged on the motherboard and electrically connected to the connection port; and the adaptation connector having a socket located on one of the end panels of the case; and
an expansion interface card having an I/O connector arranged along an edge thereof for plugging in the connection port on the motherboard.

2. The expansion structure for microcomputer as claimed in claim 1, wherein the case is provided on outer surfaces with a plurality of radiating fins.

3. The expansion structure for microcomputer as claimed in claim 1, wherein the expansion interface card is a video capture card.

4. The expansion structure for microcomputer as claimed in claim 1, wherein the expansion interface card is a sound card.

5. The expansion structure for microcomputer as claimed in claim 1, wherein the expansion interface card is an AV processing card.

6. The expansion structure for microcomputer as claimed in claim 1, wherein the expansion interface card is an external storage unit card.

7. The expansion structure for microcomputer as claimed in claim 1, wherein the expansion interface card is an all-in-one expansion interface card providing at least the functions of a video capture card, a sound card, an AV processing card, and an external storage unit card.

8. The expansion structure for microcomputer as claimed in claim 1, wherein the expansion interface card is provided with a switch unit, and the switch unit is a manual switch.

9. The expansion structure for microcomputer as claimed in claim 1, wherein the expansion interface card is provided with a switch unit, and the switch unit is controlled via a software driver.

10. The expansion structure for microcomputer as claimed in claim 1, wherein the expansion interface card is provided with at least one expansion connector.

11. The expansion structure for microcomputer as claimed in claim 1, wherein the two end panels are separately fixed to two open ends of the case.
